(19) United States
(12) Patent Application Publication
(10) Pub. No.: US 2002/0016922 A1
(43) Pub. Date: Feb. 7, 2002

(54) Secure distributing services network system and method thereof

(76) Inventors: Kenneth W. Richards, Richfield, MN (US); Arnold E. Murray, Chisago, MN (US)

Correspondence Address: MERCHANT & GOULD PC, P.O. BOX 2903, MINNEAPOLIS, MN, 55402-0903, US

(21) Appl. No.: 09/791,162

(22) Filed: Feb. 22, 2001

Related U.S. Application Data
(60) Provisional application No. 60/184,079, filed on Feb. 22, 2000.
(60) Provisional application No. 60/184,075, filed on Feb. 22, 2000.
(60) Provisional application No. 60/184,074, filed on Feb. 22, 2000.

(51) Int. Cl. H04L 9/00

(52) U.S. Cl. 713/200

(57) ABSTRACT

A persistent data control system and method of securely distributing data on a network includes the steps of providing an encoded file of a single file type having a plurality of file control fields, the file having at least one data type, and incorporating at least one encoded use right and/or access right into one of the control fields of the at least one data type. The persistent data control method is performed at an application level, and is capable of being embedded in an application which originates the at least one data type or called by an application. The persistent data control method further comprises the steps of decoding the plurality of file control fields including the file control fields for the encoded use right and/or access right, decoding the at least one data type in accordance with the access right, and rendering the decoded data type in accordance with the decoded use and access right.

### RELATED APPLICATION

This application claims the benefit of Provisional Application, U.S. Ser. No. 60/184,079, filed on Feb. 22, 2000, entitled “ENCODING AND DECODING DATA FOR PURPOSES OF SECURING AND CONTROLLING THE RENDERING OF, ACCESS TO, AND/OR USE OF THAT DATA”, by Kenneth Richards, Jane Bersie, Indulis Valters, and Stuart Dahlberg; Provisional Application, U.S. Ser. No. 60/184,075, filed on Feb. 22, 2000, entitled “ESTABLISHING A SECURE VIRTUAL PRIVATE SESSION (SVPS) OVER COMMUNICATIONS MEDIUM OR NETWORK BETWEEN A SERVER AND A REMOTE APPARATUS”, by Kenneth Richards; and Provisional Application, U.S. Ser. No. 60/184,074, filed on Feb. 22, 2000, entitled “PROCESS WHEREBY DIGITAL FILES AND THEIR DESCRIPTIONS ARE STORED IN A SECURE SEARCHABLE STRUCTURE”, by Kenneth Richards and Arnold E. Murray; which are incorporated herewith by reference.

### TECHNICAL FIELD

The present invention relates to an electronic communication network system and method thereof, and more particularly, to a secure distributing services network system and method.

### BACKGROUND

In the digital communication era, security has become a large part of an electronic communication network system, particularly a network system for distributing services, such as legal services, bank transactions, etc. In many existing security systems, digital data are encoded at a transmit end and decoded at a receive end. A security system may include mechanisms for user authentication and data encryption/decryption or referred to as encoding/decoding. Also, a security system may provide public and/or private keys to authenticate a recipient and encrypt/decrypt data sent by an owner, sender, or provider of the data (hereinafter referred to as an owner of the data). However, further improvements in transferring a public and/or private key in a secure distributing services network are desired.

In addition, an owner of the data often has certain policies and/or rules that would govern and control the rendering of, access to, and/or use of that data and its lifecycle to a targeted recipient of the data. For example, an owner of the data may only want to grant a targeted recipient the ability to read the data twice in a certain time period. Further, it is desired to control and/or enforce use rights and access rights at a user application level. The existing security systems have not been designed to provide and/or enforce these and/or other policies and rules.

It is with respect to these and other considerations that the present invention has been made.

### SUMMARY

In accordance with this invention, the above and other problems were solved by providing a persistent data control method of securely storing data and its use on an apparatus and/or distributing data on a network which includes the steps of: providing an encoded file of a single file type having a plurality of file control fields, the encoded file having at least one data type; and incorporating at least one encoded use right into one of the control fields of the at least one data type.

In one embodiment of the present invention, data is encrypted and formatted in a single file type. The encoded file includes a plurality of file control fields. At least one of the fields incorporates the persistent data control policy that controls use rights and/or access rights of a recipient. The persistent data control policy is granted by an owner.

In one embodiment of the present invention, data is encrypted and formatted in a database structure. The database structure includes a plurality of database structure control fields. At least one of the control fields incorporates the persistent database structure control policy that controls use and/or access rights of a recipient. The persistent database structure control policy is granted by the owner of the database.

Still in one embodiment, the data type may include, but not limited to, digital files, and a database structure or its elements including static image, video, text, markup language (e.g. HTML), etc.

Further in one embodiment of the present invention, the secure embedded database includes a plurality of fields which define arbitrary descriptions, file size(s), file type(s), etc.

Additionally in one embodiment of the present invention, the file(s) and their descriptions can be queried and returned independently by supplying values for a search keyword that is defined in the descriptions, without decoding the entire encoded data in accordance with encoded user access rights and use rights.

In one embodiment of the present invention, the persistent data control method is performed at an application level.

Still in one embodiment, the persistent data control method is capable of being embedded in an application which originates the at least one data type. Alternatively, the persistent data control method is called by an application.

Yet in one embodiment, the data may be encoded in a memory buffer and decoded from a memory buffer (i.e. buffer-to-buffer), or encoded in a file and decoded from a memory buffer (i.e. file-to-buffer), or encoded in a memory buffer and decoded from a file (i.e. buffer-to-file), or encoded in a file and decoded from a file (i.e. file-to-file).

Further in one embodiment, the persistent data control method further comprises the step of incorporating multiple encoded use rights into the control fields of the at least one data type.

Additionally in one embodiment, the persistent data control method further comprises the step of incorporating at least one encoded access right into one of the control fields of the at least one data type.

Yet in one embodiment of the present invention, the encoded use right is encoded with the at least one data type. Alternatively, the encoded use right is encoded independently from the at least one data type.

Still in one embodiment, the persistent data control method further comprises the steps of: decoding the plurality of file control fields including a file control field for the at least one encoded use right; decoding the at least one data type; and rendering the decoded data type in accordance with the decoded use right.

In another embodiment of the present invention, the persistent data control method further comprises the steps of: decoding the plurality of file control fields including a file control field for the at least one encoded use right; decoding the plurality of the file control fields including a file control field for the at least one encoded access right; decoding the at least one data type in accordance with the decoded access right; and rendering the decoded data type in accordance with the decoded use right.

The present invention also includes a persistent data control system for securely distributing data on a network. The persistent data control system includes: an encoded file of a single file type having a plurality of file control fields, the file having at least one data type; and means for incorporating at least one encoded use right into one of the control fields of the at least one data type.

Still in one embodiment, the persistent data control system includes: a mechanism for authenticating a user; a mechanism for encrypting/decrypting data; and a mechanism for generating a dynamic key on a secure server and transferring the dynamic key to a recipient device. In one embodiment, the dynamic key physically resides in a memory for the term of a communication session, the time defined by the owner of the data, or the life of data being rendered. The dynamic key is generated dynamically for a session and/or specific data.

The present invention further includes a method of authenticating the encoded data. The method may generate a single file type that is verifiable so as to prevent attacks and spoofing of the encoded data. For example, the single encoded file type may be checked at a firewall or a proxy to validate the data before allowing it to enter into a system, and decoded to prevent unauthorized access or attacks on the system.

The present invention also relates to a method of distributing data on a secure network system. The method includes the steps of: authenticating a user, encrypting of data with a security key, generating a dynamic key on a secure server and transferring the dynamic key to a recipient device, and decrypting the data by the security key based on the dynamic key transferred with the data or transferred independently of the data.

In one aspect of the present invention, the step of generating the dynamic key on the secure server and transferring the dynamic key to the recipient device includes generating the key dynamically for a session and/or specific data. In one embodiment, the dynamic key physically resides in a memory for the term of a communication session, the time defined by the owner of the data, or the life of data being rendered.

Unlike conventional encryption methodologies that apply encryption after or decode before the data generating or rendering application, the method in accordance with the present invention may be incorporated as part of the data generating and rendering application to facilitate the process and further insure the security of the information. For example, the method according to the present invention is a part of video codec and encodes each frame or a critical component of each frame while being assembled as a video. Accordingly, the present invention allows to securely and efficiently distribute digital data streams, for example, video or voice data streaming while such streams are being generated. In addition, the present invention allows for securely and efficiently re-applying an encoding process to the data multiple times to increase the degree of security.

The method according to the present invention also allows an owner of the data to define rules for rendering, accessing, and using the encoded data. Such rules can be a part of an encoding scheme. The rules are enforced when a recipient decodes the data.

For a better understanding of the invention reference should be made to the drawings which form a further part hereof, and to accompanying descriptive matter, in which there are illustrated and described specific examples in accordance with the invention.

### BRIEF DESCRIPTION OF THE DRAWINGS

Referring now to the drawings in which like reference numbers represent corresponding parts throughout:

FIG. 1 is a functional block diagram illustrating exemplary electronic communication methodologies for a remote authorization process.

FIG. 2 is a functional block diagram illustrating exemplary secured data distribution methodologies for a remote authorization process.

FIG. 3 is a flow diagram of one embodiment illustrating a remote authorization to render data in accordance with the principles of the present invention.

FIG. 4 is a schematic view of an exemplary composite file having one or more data type components and control components of a persistent data control system in accordance with the principles of the present invention.

FIG. 5 is a schematic view of exemplary types of an encrypted file as defined by a header of a secured embedded database of the persistent data control system in accordance with the principles of the present invention.

FIG. 6 is a functional block diagram illustrating exemplary method of encoding secured data in accordance with the principles of the present invention.

FIG. 7 is a functional block diagram illustrating exemplary method of decoding secured data in accordance with the principles of the present invention.

FIG. 8 is a schematic view of one embodiment of secured embedded database and search engine in accordance with the principles of the present invention.

FIGS. 9A-9B are flow diagrams of one embodiment illustrating a method of establishing a secured session with a registered user in accordance with the principles of the present invention.

FIGS. 10A-10F are functional block diagrams of various embodiments illustrating a method of registering and establishing a secured session with a new registered user in accordance with the principles of the present invention.

FIGS. 11A-11B are functional block diagrams of various embodiments illustrating a method of requesting for specific content or data key and rendering in accordance with the principles of the present invention.

FIGS. 12A-12D are functional block diagrams of various embodiments illustrating a method of establishing a secured session with a registered user in accordance with the principles of the present invention.

### DETAILED DESCRIPTION OF ILLUSTRATED EMBODIMENTS

In the following description of the illustrated embodiments, reference is made to the accompanying drawings that form a part hereof, and in which is shown by way of illustration several embodiments in which the invention may practiced. It is to be understood that other embodiments may be utilized as structural changes may be made without departing from the spirit and scope of the present invention.

The present invention provides a persistent data control method of securely distributing data on a network which includes the steps of: providing an encoded file of a single file type having a plurality of file control fields, the encoded file having at least one data type; and incorporating at least one encoded use right into one of the control fields of the at least one data type.

Data is encrypted and formatted in a single file type. The encoded file includes a plurality of file control fields. At least one of the fields incorporates the persistent data control policy that controls use rights and/or access rights of a recipient. The persistent data control policy is granted by an owner of the data. Alternatively, data is encrypted and formatted in a database structure. The database structure includes a plurality of database structure control fields. At least one of the control fields incorporates the persistent database structure control policy that controls use and/or access rights of a recipient. The persistent database structure control policy is granted by the owner of the database.

The data type may include, but not limited to, digital files, and a database structure or its elements including static image, video, text, markup language (e.g. HTML), etc. The secure embedded database includes a plurality of fields which define arbitrary descriptions, file size(s), file type(s), etc. The file(s) and their descriptions can be queried and returned independently by supplying values for a search keyword that is defined in the descriptions, without decoding the entire encoded data in accordance with encoded user access rights and use rights.

The persistent data control method of the present invention can be performed at an application level. The method is capable of being embedded in an application which originates the at least one data type or being called by an application.

The present invention also provides a persistent data control system and method thereof. The persistent data control system includes a mechanism for authenticating a user, a mechanism for encrypting/decrypting data, a mechanism for generating a dynamic key on a secure server and transferring the dynamic key to a recipient device, and a mechanism for authenticating the encrypted data.

It is appreciated that various standards of user authentication can be used within the scope of the present invention. Examples of user authentication methods are as follows:

1) Basic authentication methods:

i) Challenge handshake authentication protocol (CHAP) response encrypted user name and password transfer;

ii) Basic or PAP (Password authentication protocol) clear text transfer authentication; or

iii) 2-factor authentication—server to client and client to server when coming over.

2) Certificate of Authority (CA)—where a third party provides user authentication to the server; or

3) Digital Signatures—where an owner signs its identification in a digital format.

The persistent data control system in accordance with the present invention may incorporate the above authentication standards to authenticate a user to a server or between any two users, devices, or applications. Once a user is authenticated, the persistent data control process uses an encryption schema for data communications to transfer a dynamic key generated on a secure server to a persistent data control application on a recipient device.

It is also appreciated that various standards of encryption/decryption methods can be used within the scope of the present invention. Standard encryption/decryption methods are hardware and software solutions that encrypt/decrypt based on a defined protocol between the two communicating devices and exchange of keys. The persistent data control system in accordance with the present invention may use or incorporate the same encryption/decryption schema as that is used for communication between devices, for example the Data Encryption Standard (DES) or Blowfish (A 64-bit block symmetric cipher consisting of key expansion and data encryption), etc. In one embodiment of the persistent data control system of the present invention, the data is encrypted at an application level using the same or another cipher and then be encrypted by a protocol used by a network which may be arbitrated or not.

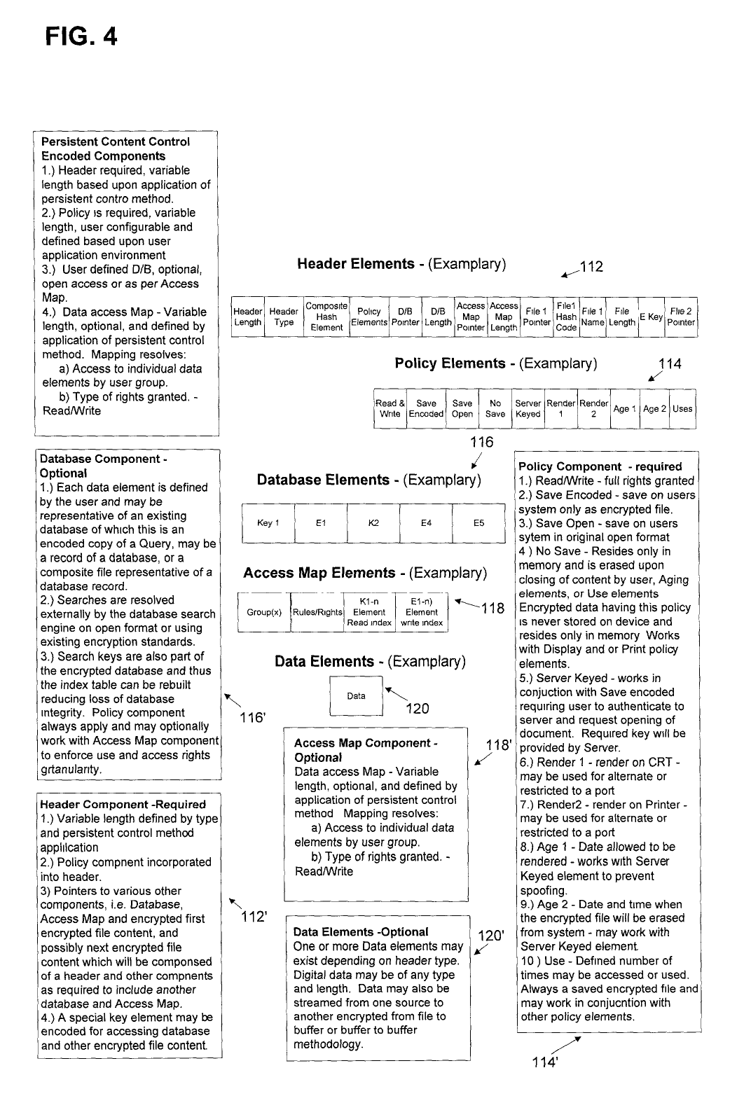

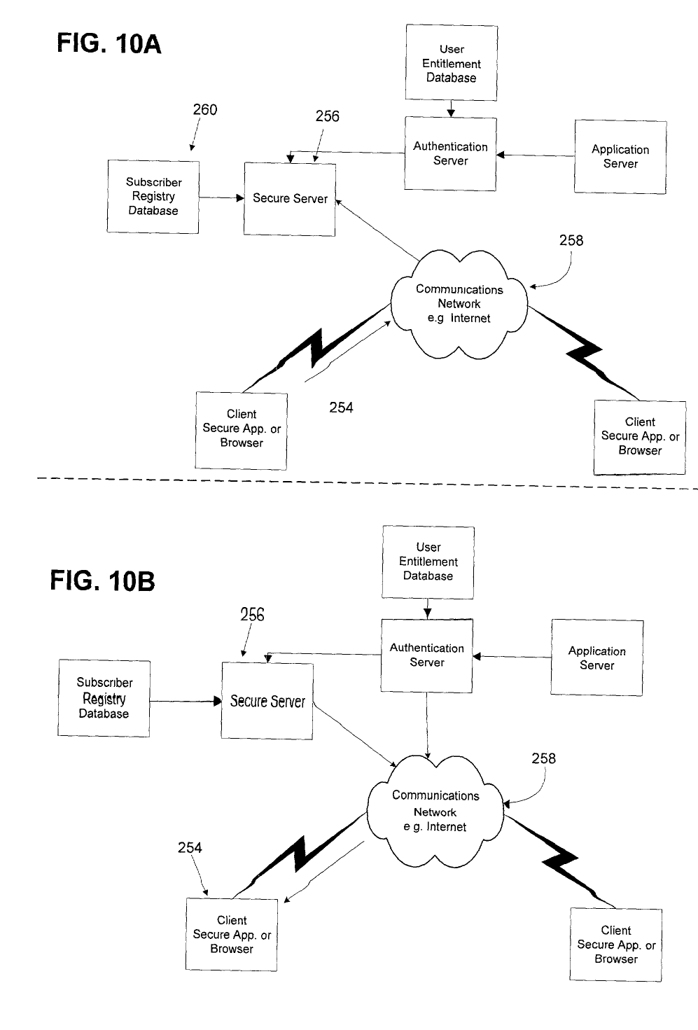

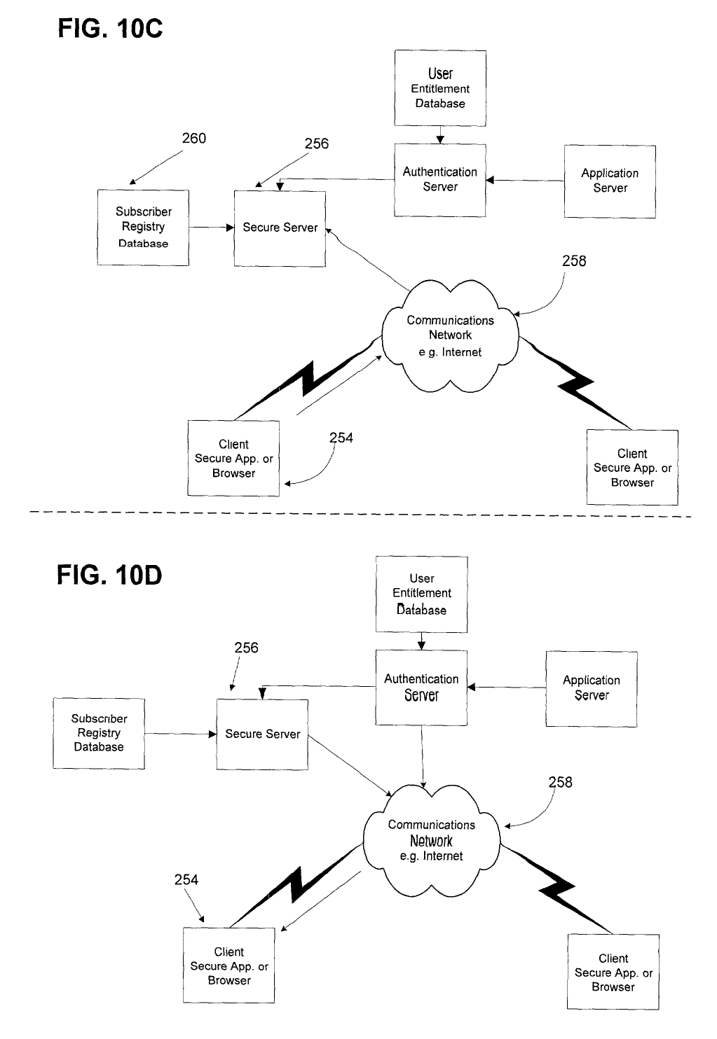

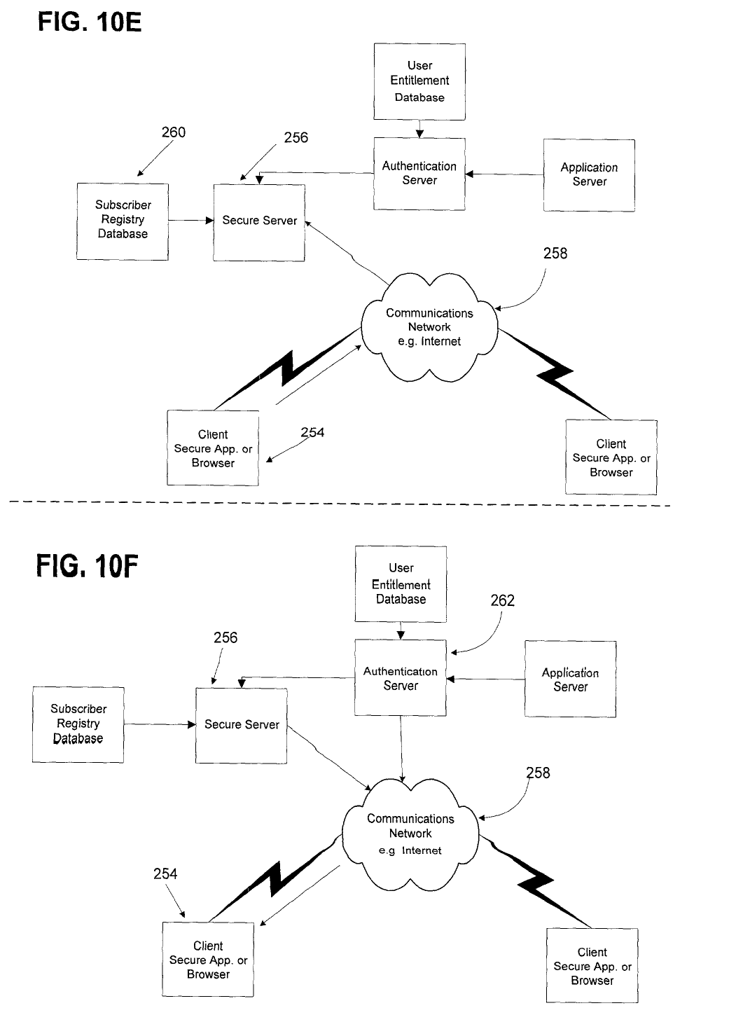

A dynamic key used in connection with the persistent data control system of the present invention is a key that is not physically stored on a device but resides only in a memory for the term of a session, time defined by an arbitrating device such as the server, or for the life of a data being rendered. The key is generated dynamically for a specific session and/or specific data. A dynamic key can be transferred via a standard encryption protocol that is used by a network for establishing the dynamic key for a session as shown in FIGS. 10A-10F, 11A-11B, and 12A-12D. Alternatively, a dynamic key can be transferred through the use of headers as shown in FIGS. 4 & 5. The dynamic key is changed on the fly for each session or for a specific data. The dynamic key preferably resides in a memory for the term of a communication session, the time defined by the owner of the data, or the life of a data being rendered.

In addition, the persistent data control system of the present invention controls the access of the encrypted data based on a set of rules or policies and enforces the rules or policies at an application level upon rendering the data at a recipient end.

The data is preferably encrypted and formatted in a file type format. The file includes a designated portion, for example, a header, which has a plurality of fields. At least one of the fields defines a rule and/or policy that controls use rights and access rights of a recipient. The use rights and access rights are granted by an owner of the data.

The persistent data control system includes a secure embedded database and a search engine. The data may include digital files, their descriptions, user rights of access, rendering, and use. The data are stored in a secure searchable structure. The secure embedded database includes a plurality of fields that define arbitrary descriptions, file size(s), file type(s), and an arbitrary number of files associated with the descriptions. Further, the file(s) and their descriptions are preferably queried and returned independently by supplying values for a search keyword that is defined in the descriptions.

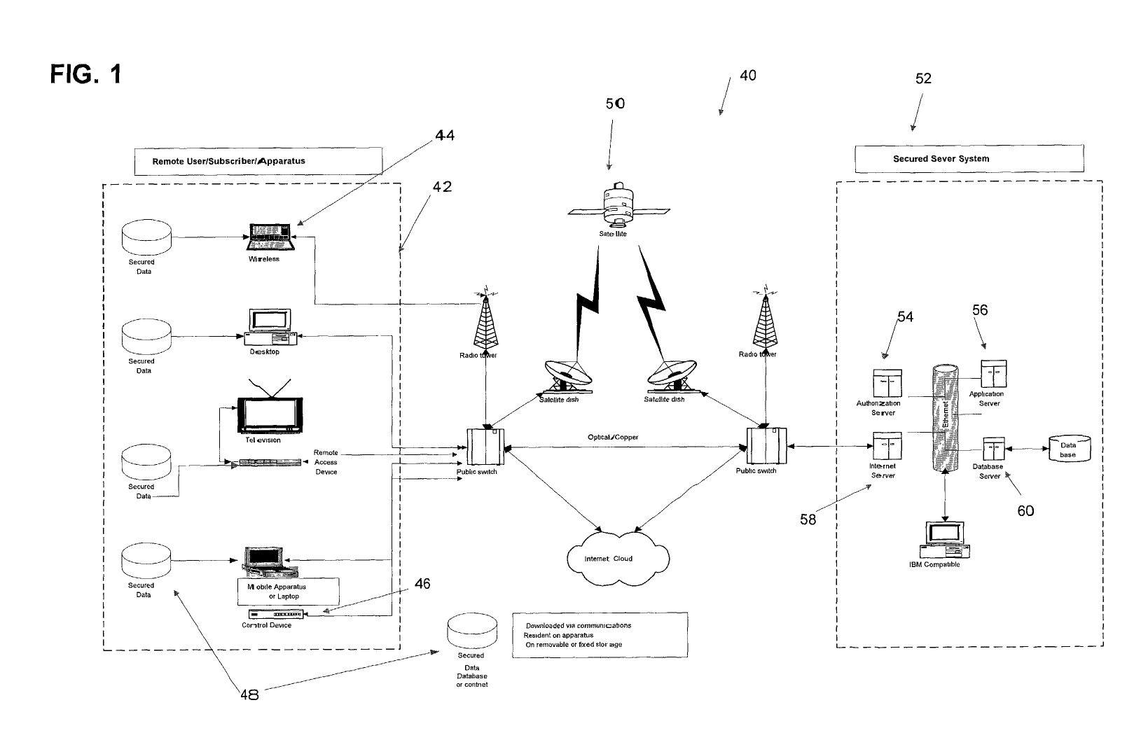

FIG. 1 illustrates exemplary electronic communication methodologies of a persistent data control system 40 for a remote authorization process for accessing and using secured data 48. A remote user/subscriber/apparatus 42 may be any one of a wireless electronic device, a desktop computer, a television, a remote access device, a mobile device, a laptop, another server, or others that would become apparent to one skilled in the art. The remote apparatus 42, such as a desktop or laptop device, may have the communications and data control application process or device incorporated therein for providing encryption/decryption access and control of the received and sent secured data or database. As shown, the remote apparatus 42, such as the television, the desktop computer, the mobile device, and the laptop, may be connected to a communications and/or control device 46 incorporating the data control application process for providing and controlling encryption/decryption and control of the received and sent secured data or database.

In FIG. 1, the remote user/subscriber/apparatus 42 is in communication with a secured data 48 or has received a secured data 48 that is either downloaded via communication to the apparatus 42 or is available on removable or fixed storage media. The secured data 48 may be transferred from an owner of the secured data, through various communications channels 50, such as radio towers, public switch networks, satellite dishes, optical fiber, copper wire, the Internet, etc., to a recipient apparatus 42 or secured server system 52. At the secured server system 52, an authorization server 54, an application server 56, an Internet server 58, a database server 60 are interconnected through a network, e.g. the Ethernet, to provide services and exchange of the secured data. The secured server system 52 generate all dynamic keys for an encoded session as well as the secured data 48, and provide the keys and the data via the communications channels 50 to the remote apparatus 42 incorporating the controls 46 and application 44 for decoding and enforcing of the policies and rules associated with the secured data or database 48. The remote user/apparatus 42 may further encode secure data or changes to the secure database 48 and send such encoded data to the secure server system 52 for rendering the data or database update, or to another remote user/apparatus 42 for rendering in accordance with the rules and policies incorporated therein.

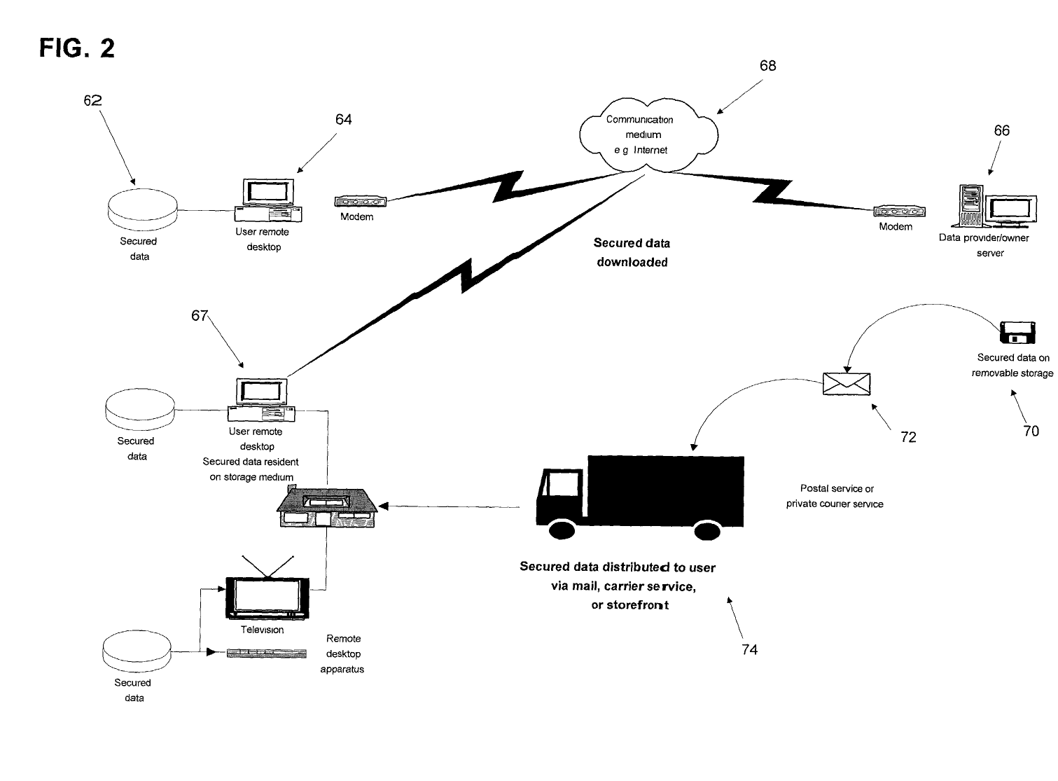

FIG. 2 illustrates exemplary secured data distribution methodologies. Secured data 62 is downloaded from a remote site 64 to a secured server system 66 via communication media 68, such as the Internet, then to a recipient 67 via the media 68. Alternatively, the secured data 62 is stored on removable storage media 70 and delivered manually via a postal service 72 or courier 74 to the recipient 67.

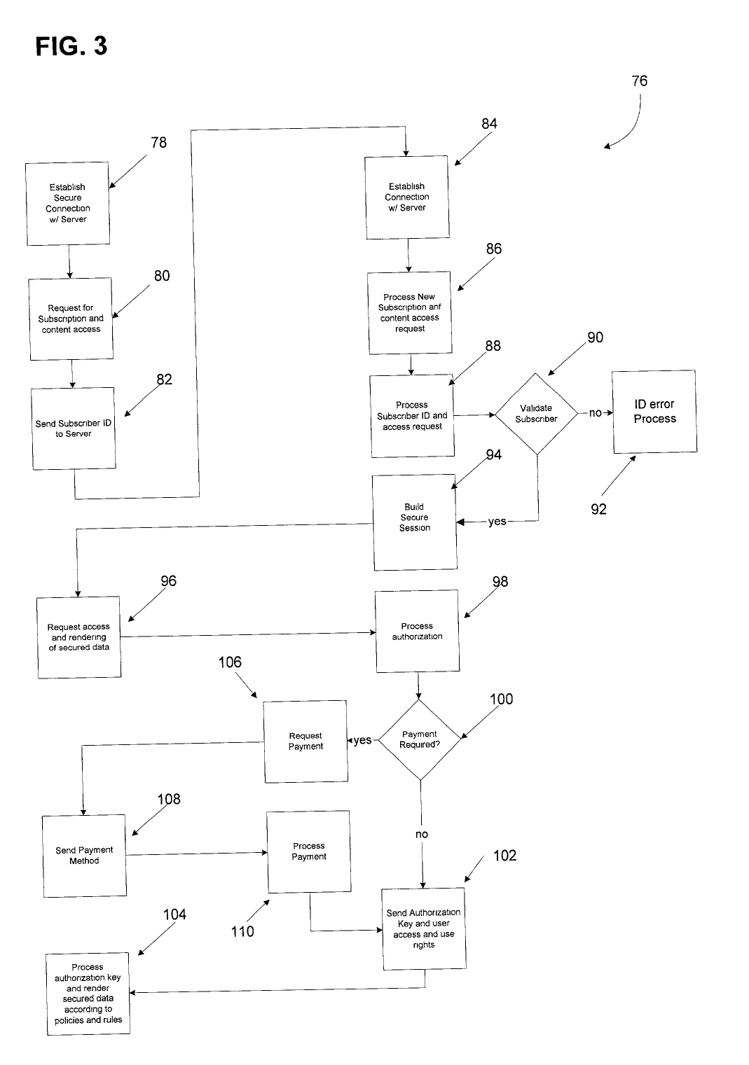

FIG. 3 is a flow diagram of one embodiment illustrating a remote authorization process 76 to render data in accordance with the principles of the present invention. The process 76 starts with an operation 78 of establishing a connection with a server. Then, a request for subscription and access by a user/apparatus to the persistent data control system is sent to the server in an operation 80 along with a subscriber ID in an operation 82. Next, a connection is established with the server in an operation 84, and a new subscription and data access request is processed in an operation 86. Then, the subscriber ID is processed in an operation 88. If the subscriber ID is determined in an operation 90 to be invalid, i.e. the “no” path, an ID error is indicated in an operation 92 that terminates the process 76. If the subscriber ID is determined in the operation 90 to be valid, i.e. the “yes” path, then a secured session is built in an operation 94. Then, a request for rendering of the secured data is made in an operation 96. Next, access and user rights policy of a recipient is processed in an operation 98.

The process 76 may determine whether a payment is required for rendering the secured data in an operation 100. If no payment is required, i.e. the “no” path, an authorization key and user access and use rights are given to the recipient in an operation 102, and the authorization key and user access and use rights are is used to render the secured data to the recipient in an operation 104.

If a payment is required from the operation 100, i.e. the “yes” path, a request for payment is sent to the recipient in an operation 106. The recipient may respond by sending a payment method in an operation 108. Then, the payment is processed in an operation 110, and the authorization key and user access and use rights are is sent to the recipient in the operation 102. Next, the authorization key and user access and use rights are used to process and render the secured data. Then, the process 76 is terminated.

FIG. 4 is a schematic view of an exemplary composite file having one or more data type components and control components of a persistent data control system in accordance with the principles of the present invention. FIG. 4 illustrates control information including the control components, such as header elements, policy elements, and access map elements, etc. FIG. 4 also illustrates data type information including data type components, such as database elements, data elements, etc. The data or datum is encrypted in a file format or type that preferably includes a header component 112, a policy component 114, a database component 116, an access map component 118, and adata component 120.

As shown in FIG. 4, the header component 112 includes elements such as a header length, type, policy elements, composite hash element of the encoded data, database pointer, database length, access map pointer, access map length, one or more file pointers, file name(s), file length, encryption key (E key), etc. A further detailed description of the elements of the header component 112 is shown in a box 112′. A header length is varied depending on different types of persistent data control methods. The policy component 114 is incorporated into one of the elements of the header component 112. Also, pointers to various other components, such as a descriptive database composed of discrete elements, access rights map, first encrypted file data, and possibly next encrypted file data, are incorporated into elements of the header component 112. In addition, an encryption/security key for accessing the database and other encrypted file data is incorporated into one of the elements of the header component 112. It is appreciated that the elements in the header component 112 can be embedded in anywhere within the encoded composite file and data type files without departing from the present invention, for example, a footer, etc. For simplicity and illustration, a header component is hereinafter described as an example.

The policy component 114 includes elements that define recipient's access rights to the data, such as the rights to “read/write”, “save encoded”, “save open”, “no save”, “server keyed”, “render 1”, “render 2”, “Age 1”, “Age 2”, and “Use”, etc. A further detailed description of the elements of the policy component 114 is shown in a box 114′. The “read/write” element indicates that full rights are granted to a recipient of the data. The “save encoded” element allows the recipient to save the data on its system only as an encrypted file. The “save open” element allows the recipient to save the data on its system in an original open format of the data. The “no save” element only allows the data to reside in a memory and to be erased upon closing of the data file by the recipient, upon aging after a certain period of time, or a pre-defined user element, etc. The “server keyed” element allows the recipient to work in conjunction with “save encoded” element. The “server keyed” element requires the recipient to authenticate itself to the server and request opening of a file. A required key will be provided by the secure server. The “render 1” element and “render 2” element allow the recipient to render the data on different ports, such as a CRT or a printer, etc. The “age 1” element defines a specific date that the recipient needs to render the data so as to prevent spoofing. The “age 2” element provides a specific time and date that an encrypted file will be erased from the system. The “age 1” element and “age 2” element may work in conjunction with the “server keyed” element. The “use” element defines the number of times that the data may be accessed or used. The “use” element may work in conjunction with the other policy elements.

As shown in FIG. 4, the exemplary database component 116 includes elements “Key 1”, “E1”, “K2”, “E4”, “E5”. A further detailed description of the elements of the database component 116 is shown in a box 116′. The database elements can be defined by an owner or can be a representative of an existing database that may be an encoded copy of a query, a record of a database, or a composite file, etc. Searches of the database are performed in such a manner that it does not require opening of the encoded file or database and limit access to its elements according to the map access rights elements 118 and limit the rendering in accordance with the policy components 114. Also, search keys may be a part of an encrypted database whereby an index table can be rebuilt to reduce loss of database integrity. In addition, the policy component 114 and the access map component 118 may work in conjunction with the database component 116 to enforce the use and access rights granularity.

In FIG. 4, the exemplary access map component 118 includes elements “Group(x)”, “Rules/Rights”, “K₁₋ₙ element read index”, “E₁₋ₙ element write index”. A further detailed description of the elements of the access map component 118 is shown in a box 118′. The access map elements define access to individual data elements by user group, and the type of rights granted, e.g. read only, write only, read/write, etc.

The exemplary data component 120 includes one or more data elements. A further detailed description of the data elements is shown in a box 120′. One or more data elements may exist depending on a header type. Digital data may be of any type and length. Data may also be streamed from one source to another, encrypted from file to buffer, buffer to buffer, buffer to file, or file to file.

It is appreciated that other components may be included in a database file within the scope of the present invention. Also, it is appreciated that other elements may be included in each of the components without departing from the scope of the present invention.

It is also appreciated that since all encoded header data, database, and any other data are encoded as a single data file or stream being singular in type, the data may be checked by the application before opening via the various embedded hash elements. Accordingly, the security and integrity of the data is further maintained, firewall requirements are simplified, and the potential of firewall penetration is reduced.

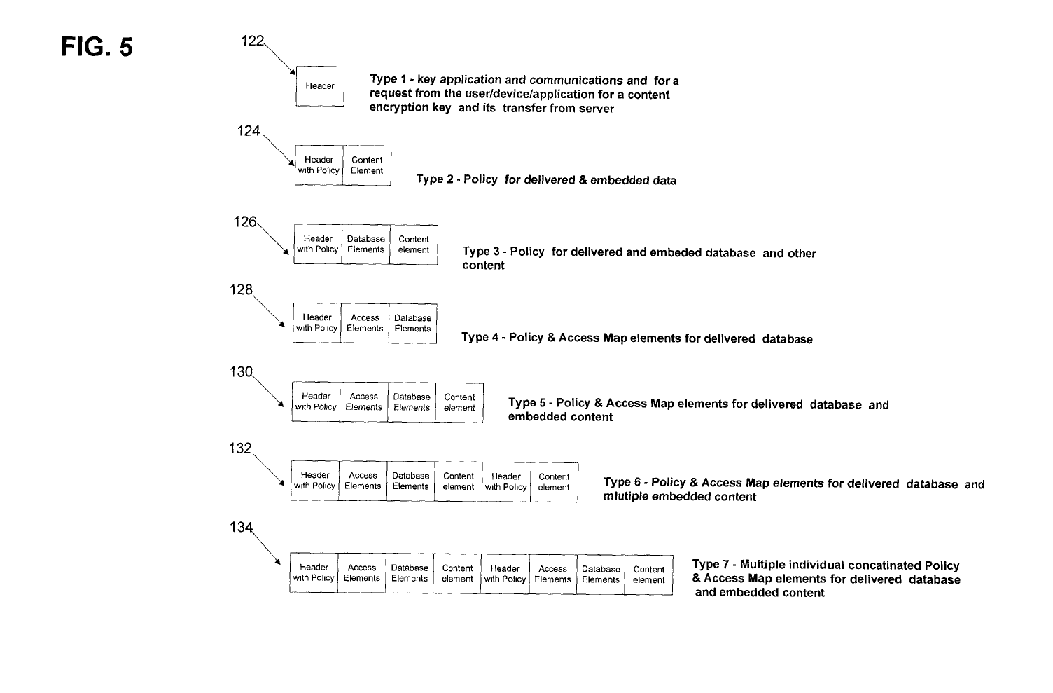

FIG. 5 is a schematic view of different types of an encrypted file as defined by a header of a secured embedded database of the persistent data control system in accordance with the principles of the present invention. In type 1, a file 122 has a header element without other elements. The type 1 file 122 is a key application for a request from the user/device/application for a data encryption key and its transfer from the secure server. In type 2, a file 124 includes the header element with the policy element and data element. The policy element defines the policy for delivered and embedded data. In type 3, a file 126 includes the header element with the policy element, database element, and data element. The policy element defines the policy for delivered database and embedded data. In type 4, a file 128 includes the header element with the policy element, access element, and database element. The policy element defines the policy for delivered database. In type 5, a file 130 includes the header element with the policy element, access element, database element, and data element. The policy element defines the policy for accessed, delivered, and embedded data. In type 6, a file 132 includes the header element with the policy element, access element, database element, data element, another header element with a policy element and data element. The policy elements define the policies for delivered database and multiple embedded data. In type 7, a file 134 includes the header element with the policy element, access element, database element, data element, another header element with a policy element, access element, database element, and data element. The policy elements define the policies for multiple accessed, delivered, and embedded data.

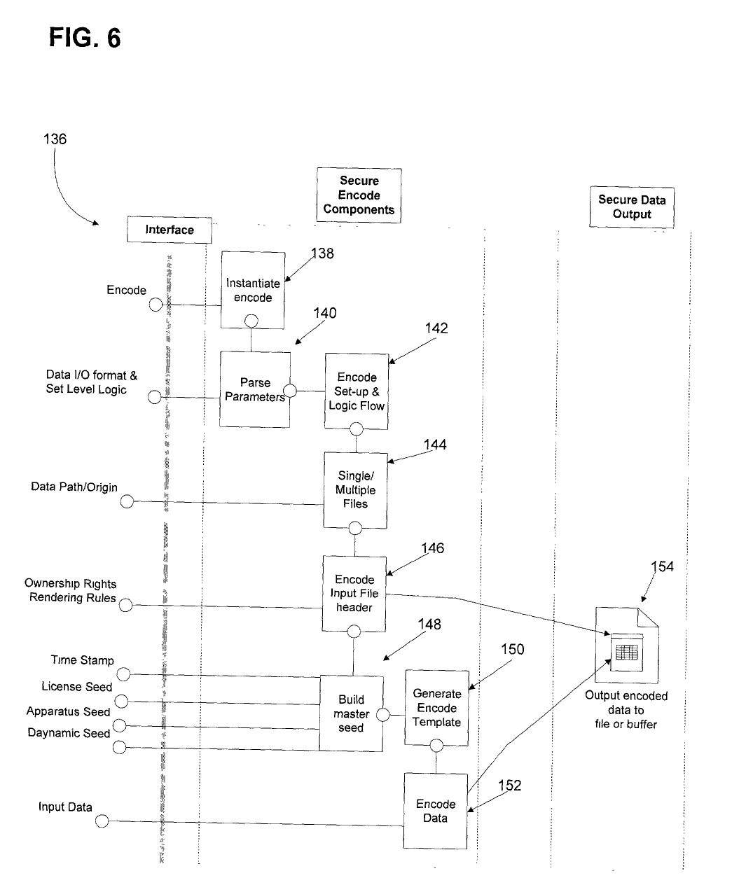

FIG. 6 is a functional block diagram of one embodiment of a method 136 of encoding secured data component in accordance with the principles of the present invention. Illustrated are the interface components, the secure software or logic components, and the secured data output. An owner of the data instantiates a request for an encoding process in block 138. Then, encoding parameters in block 140 which are input via data I/O format and level logic are used to set logic flow for setting up the encoding process in block 142. Next, the process 136 determines whether a file is a single file or multiple files in block 144. The determination may be made based on a data path or data origin. Next, the process 136 generates a file header based on the rights and rules defined by the owner in block 146. Then, the encoder process 136 generates a master seed based on a time stamp, a license key, an apparatus key, and a dynamic key in block 148. Next, an encoding template is generated in block 150 based on the master seed and key set for the encoding of the data components and of the final composite file. Then, the input data is encoded according to the encoding template in block 152. Finally, the encoded data is outputted to a file or a buffer that include both the encoded data and the header in block 154.

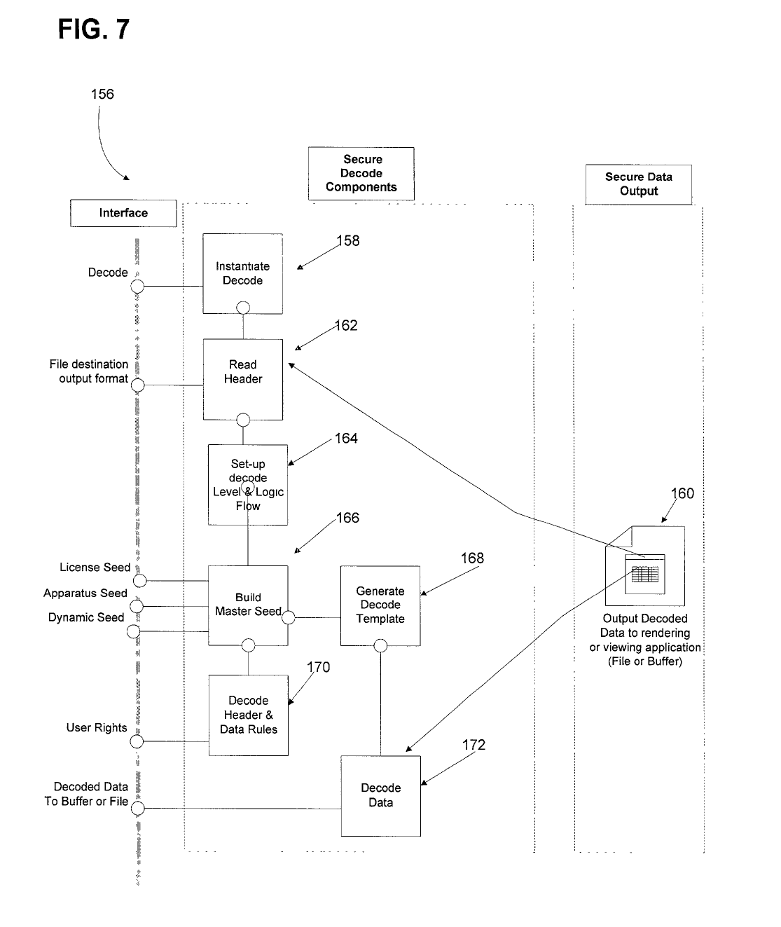

FIG. 7 is a functional block diagram of one embodiment of a method 156 of decoding a secured file in accordance with the present invention. Illustrated are the interface, the secure software or logic components, and the secured data output components. A recipient of the data instantiates a request for a decoding process in block 158. The data in the received file or buffer is decoded into a header component and a data component in block 160. Then, the process 156 reads the header in block 162 to determine the file destination and output format. Next, the process sets up a decode level and logic flow in block 164. Then, a master seed is generated in block 166 that determines a license key, an apparatus key, and a dynamic key. Next, a decoding template is generated in block 168 based on the master seed and the key set for decoding the data components and the final composite file. Further, the header is decoded to determine the policies and rules for the recipient's use rights of the data in block 170. Finally, the data is decoded based on the user rights in block 172.

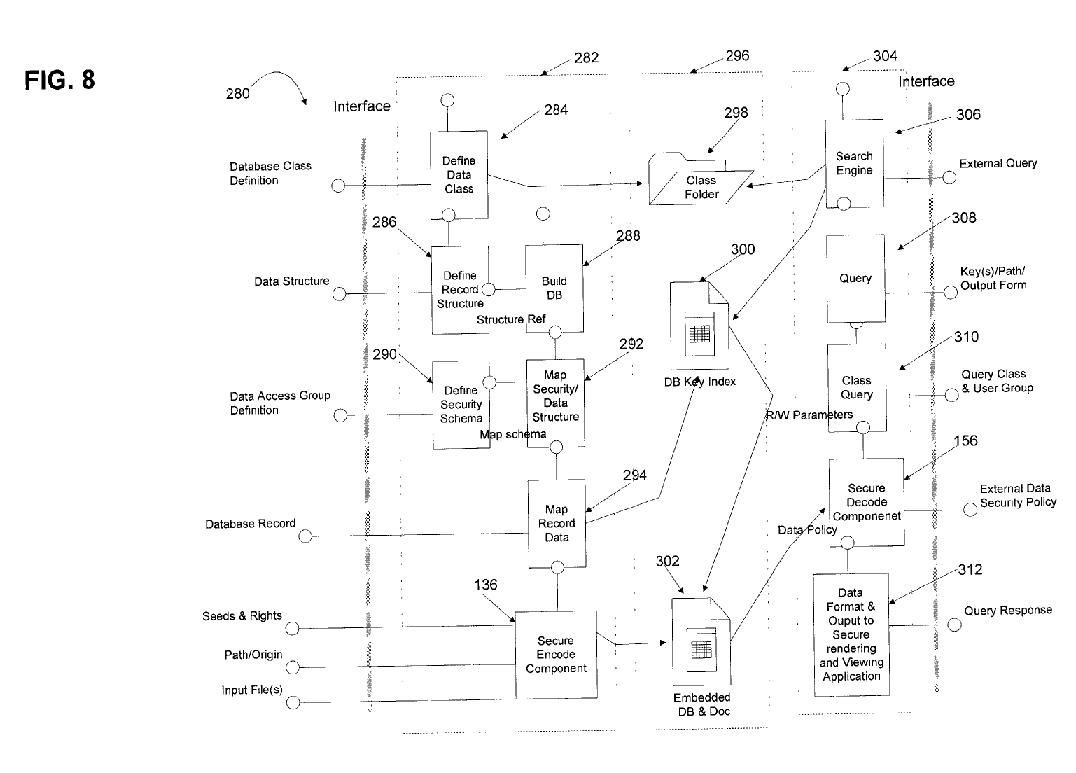

FIG. 8 is a schematic view of one embodiment of secured embedded database and search engine 280 in accordance with the principles of the present invention. Illustrated are interfaces, a secure database record generation process 282, a secured data or database output process 296, a search engine and secure query output process 304. The secure database record generation process 282 is initiated upon recipient of a data class definition 284, a database element structure in block 286, a user data access group definition in block 290, and data elements of the record in block 294. The received information may be provided from existing databases and security components of the system or via a custom interface where they may be entered as required. The data class in block 284 is used by the record structure definition in block 286 to organize the data elements for building of an encoded database in block 288. Furthermore, the defined data class in block 284 is used to generate a unique file folder 298 of the secured data or database output process 296 for all records generated using a given data structure. The data security schema in block 290 is mapped to the encoded database built in block 288 by block 292 to define the user group access rights to individual data elements as defined by the owner of the database and presented to the appropriate interface. The output of the encoded database block 288 generates a database key index file 300 for later queries by a search engine. The database key index file 300 may be encoded. Each independent data record using the mapped database structure generated by block 292 may be entered and mapped into a database according to block 294. The mapped data from block 294 and any other input data is encrypted according to the secure encode components of the process 136 and output to the appropriate class folder 298 for the defined database structure. The mapped data record in block 294 updates the database key index file with each new set of search keys and indexes for each new data record entered using the same structure.

The secured data or database output process 296 generates a unique class folder, e.g. the class folder 298, for each unique database structure generated from the build database block 288 for a set of data records. A unique key index file, e.g. the index file 300, is created for each unique structure created in block 288 and is updated with the keys and index data for each record having the same unique class and database structure. An encoded database and data record 302 is generated by the secure encoded components in the process 136 and contains all user rights to which the user has access rights as defined and mapped by block 292.

The secure query output process 304 is initiated by a user requesting a specific data by a user having a search engine 306 and a secure encode/decode application software. The search engine 306 receives query information in block 308 composed of the keys, path and output form for the queried data as well as the data class if required that is provided a the class query in block 310. The search engine 306 opens the appropriate class folder 298 or searches all class folders having the same key for records that meet the query from block 308. Each encoded database record file 302 that matches the key is presented to the secure decode components in the process 156. The secure decode components decode only those elements the user has rights to based upon the user's group definition and the encoded rights to the individual data elements and embedded data. The secure decode components in the process 156 provide the resultant decoded data to data formatting and secure rendering and viewing application in block 312.

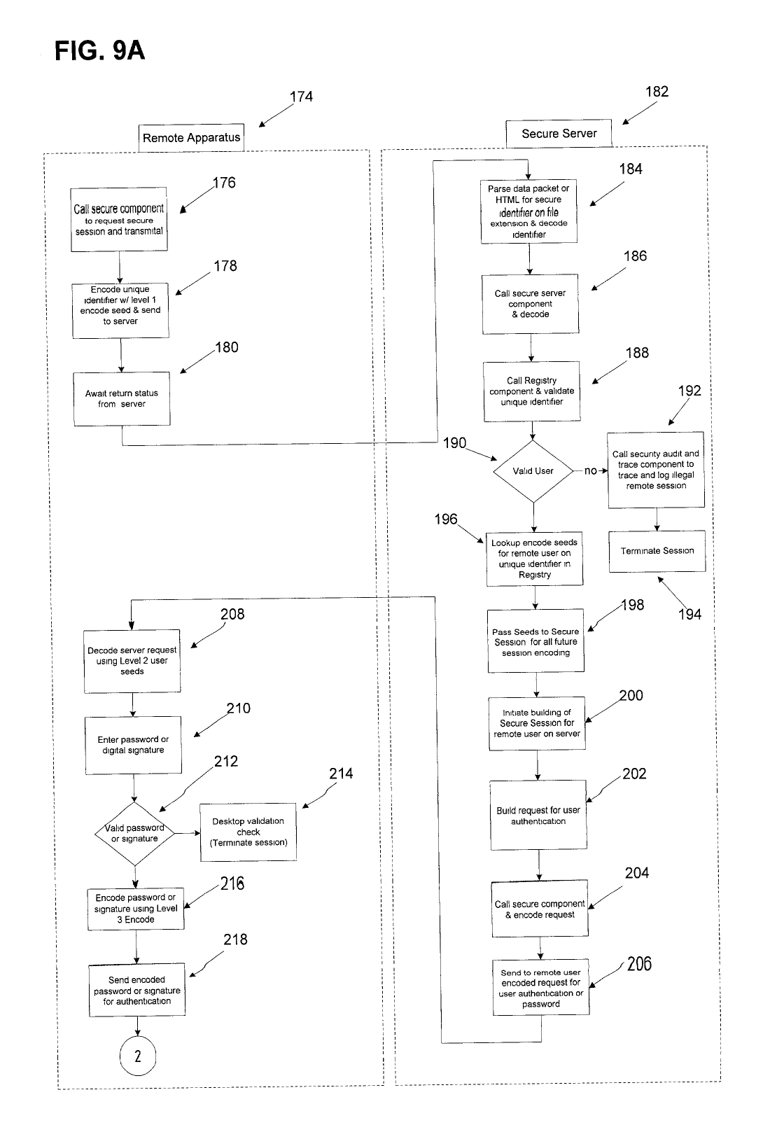

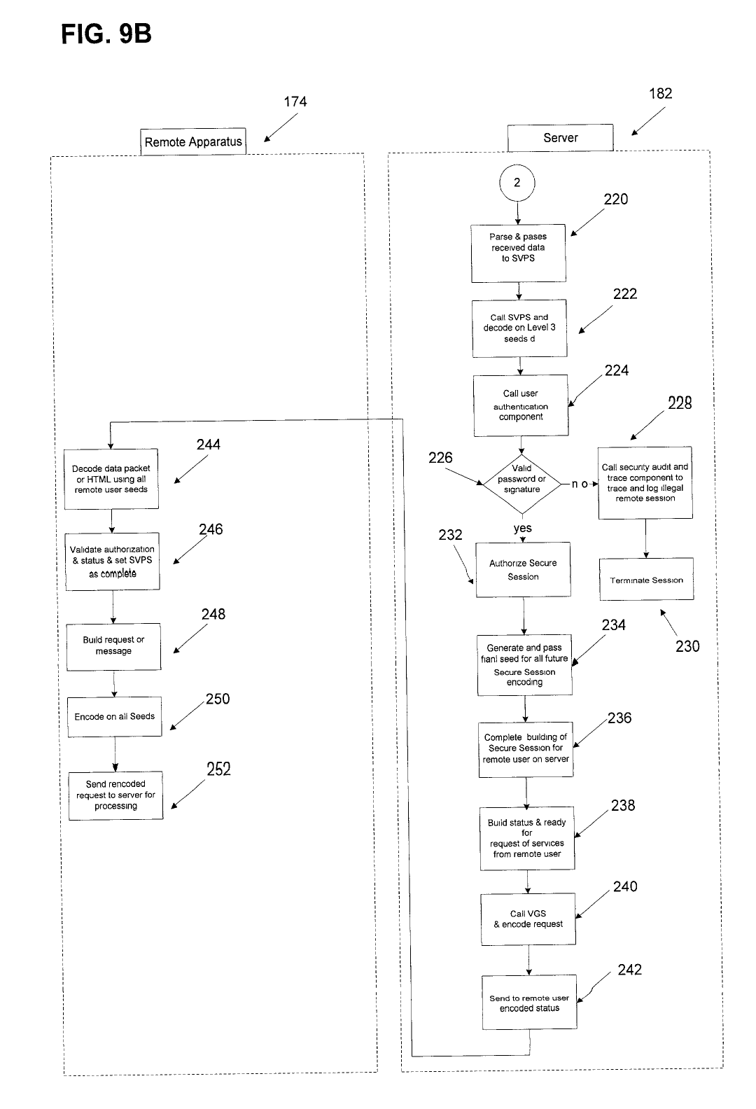

Turning now to FIGS. 9A-9B, one embodiment of a flow diagram for establishing a secured session with a registered user in accordance with the principles of the present invention.

Generally, a secured session can be established in an environment comprising the following components: (1) an Internet browser or application program that includes a persistent data control application for securely encoding and decoding digital data on a networked or remote apparatus; (2) one or more servers or another remote or networked computer which includes control, communication and application programs, the data, and the persistent data control application for securely encoding and decoding data; and (3) a communications medium, which may be public or private and which may be wireless, satellite, landline or a local network, over which the server and a remote apparatus establishes a communication link.

For purposes of describing and illustrating the process of establishing a secured session, the following description of the illustrated embodiments utilizes the Internet as an example of a relevant communications medium. However, it will be appreciated by those skilled in the art that the present invention is not limited to the use of the Internet as any suitable computer network may be substituted without departing from the spirit and scope on the present invention.

When the Internet is the communications medium, the application to establish a secured session resides on an Internet server, or another server, which will be referred to as a secure server. The secure server makes its resources available to an Internet server. Throughout the remainder of this description of the various embodiments of the present invention, the server on which the persistent data control application resides will be referred to as the secure server.

A browser application residing on the remote apparatus has access to the persistent data control application. A secured session is configurable to meet a security policy of the data owner and can be customized to control the rendering, access and use of the secured data residing on the remote apparatus according to a set of rules defined by the owner.

The implementation of a secured session may involve the utilization of multiple encryption keys. An example of utilizing five encryption keys is presented below:

1. The first key is a fixed internal or private key accessible only by an internal code used to open a header of the encoded data.

2. The second key is a dynamic public key that may be changed with each new session or block of encoded secured information sent by the secure server as a part of a secured session.

3. The third key is a license number of the persistent data control application installed on a remote apparatus. This private, unique key is a part of a registry database and a part of the persistent data control application on the secure server, and is accessed by a hashed unique browser or user identifier associated with the persistent data control application installed on the remote apparatus. The unique identifier associated with a unique license number is embedded in the persistent data control application installed on the remote apparatus. The unique identifier is encoded and passed to the secure server. As such, the identifier may be is known prior to initiating the first secured session and is therefore not transmitted across the Internet.

4. The fourth key is a unique identification number of the remote apparatus on which the persistent data control application is installed. This is also a private, unique key that is encoded using the persistent data control application and transmitted over the Internet one time only as a part of the initial persistent data control application registration. The secure server adds the fourth key to its persistent data control application registry database and associates the fourth key with the corresponding license number of the persistent data control application installed on the remote apparatus and the unique browser identifier. Before decoding any secured block of information that has been received by a remote apparatus, the persistent data control application installed on that remote apparatus retrieves the unique machine identifier, e.g., manufacturer's serial number, of that apparatus and uses it as one of the decode/encode keys. If the decode is successful, the apparatus has been validated.

Furthermore, the persistent data control application passes the unique machine identifier to the secure server where the machine identifier is in the registry database and is used as one of the encode/decode keys for that specific remote apparatus. This prevents any attempts of unauthorized decoding of secured information on any other apparatus. In addition, the persistent data control application will inform the secure server that an unauthorized attempt has been made to decode secured information so that an appropriate action can be taken. Such action may comprise erasing the secured data from the remote apparatus or disabling the apparatus from obtaining a secured session by posting status in a secure server registry database.

5. The fifth key is an optional key that can be implemented at a host Web site according to the requirements of the data owner. As an example, a user password or a digital signature or a server controlled key could be used separately from or in tandem with, the authentication server described below.

As described herein, a secured session is built in several stages. Each successive handshake between a remote apparatus and the secure server delivers the session to a more secure level until ultimately all data is encoded using a single set of keys that lock the remote apparatus, the user, and the secure server into the secured session. These same circumstances apply for all transmissions originating either at the remote apparatus or a server.

Two forms of a secured session may be built. The secured session may be initiated through either a public Web site and/or a private Internet network. Furthermore, the secured data can be rendered, accessed or used by a remote apparatus upon establishing a communication session with a control apparatus that provides information and key(s) to unlock the secured data for rendering, accessing, or using by the remote apparatus. These three components will be described below.

I. Secured Session Form 1: Public Web Site

As an example, the first form of a secured session allows a session to be initiated through a public Web site. All other services that are provided by the Web site to the public are also available, thus requiring only one hosted Web site. However, the secured data is accessible only to those remote browsers which have the persistent data control application and which are subscribers to the secured services of that Web site.

A connected browser to which the persistent data control application has been integrated initiates a first-time secured session with a secure server. The persistent data control application encodes a block of data having the following three unique components: (1) a unique encoded header; (2) the encoded data; and (3) a unique persistent data control application file extension. The header and the file extension are specific to the persistent data control application. A unique, dynamic public key used to encode the unique identifier of the browser's persistent data control application is placed in the encoded header. The secure session having a requirement for user authentication is initiated upon such authentication using existing standards for authentication, such as a digital signature method or a public/private key exchange. A dynamic key generated by the secure server may then be securely transmitted to the browser secure application utilizing the standard digital signature exchange or public/private key encryption scheme. Such dynamic key is retained in static memory for a maximum period of the duration of the session and is not stored on a permanent storage medium. A unique identifier of the browser's persistent data control application is encoded, which will be the first of the three keys required to fulfill a secured session between the secure server and the browser. The browser sends this unique encoded block of data via the Internet to the secure server, where the file extension and header type is recognized and passed to that server's persistent data control application for decoding. The secure server uses the unique browser identifier to look up the associated unique key located within the persistent data control application registry database. This first unique key is the license number for the connected browser's persistent data control application.

The secure server begins building a secured session for the browser that will exist until the secured session is terminated. The secure session having a requirement for user authentication is initiated upon such authentication using existing standards for authentication such as a digital signature method or a public/private key exchange. A dynamic key generated by the secure server may then be securely transmitted to the browser secure application utilizing the standard digital signature exchange or public/private key encryption scheme. Such dynamic key is retained in static memory for a maximum period of the duration of the session and is not stored on a permanent storage medium. The persistent data control application creates a key set including the public key combined with the first unique key and the dynamic key when specified by the system. The secure server encodes on that key set a request for the second unique private key. The browser decodes the request on the key set and responds by retrieving the unique machine identifier of the remote apparatus on which the persistent data control application is installed and from which the browser is operating. The browser then encodes the second unique key, e.g. the unique machine identifier, which, in combination with the previous key set, forms a final key set for all future encoding and decoding. This final key set and the dynamic key are used by the secure server and the browser for all transmissions during this secured session and for all future secured sessions between this browser/remote apparatus and this secure server.

If the licensed persistent data control application associated with that specific remote apparatus were to be re-installed on another apparatus, the secure server detects an error. In other words, the link between the persistent data control application license and the remote apparatus ID forever associates or locks that first secured session and each subsequent secured sessions initiated by that licensed persistent data control application user to the specific remote apparatus from which the first security session was initiated.

The secure server finalizes the building of the secured session by registering the second unique key in the registry database, and encoding status of the secured session established and sending it to the remote browser. All future data will be encoded and decoded. Once the secured session is established, the HTML, frames, JAVA applets and tables, only the data associated with the HTML page, or any other data formatted for a specific application using a secured session is secured, depending upon how and where the secured session is installed on the secure server and on the remote apparatus. All subsequent connections with the secure server by a remote browser that is registered require the user authentication process, the generation and passing of the dynamic key to the browser and the browser returning the encoded unique identifier to establish a secured session.

Furthermore, an alternative method if the Web site requires user authentication, the secure server will, before establishing the secured session, present an encoded request to the browser for a user password or digital signature. The browser will respond to the request by submitting the user's password and/or a digital signature, based upon the owner's security policy. Authentication of the user is processed giving the user entitlement to applications and information granted by such hosted web services.

A variation on the public version of the persistent data control application may be implemented whereupon, once the persistent data control application is installed, that desktop/user may register with any other server using the public secured session to control secure data delivery or to secure a transaction over the Internet, such as ordering and paying for products. This feature of the persistent data control application includes a secured database on the remote apparatus, transparent to the user that retains information pertinent to all secure servers with which the desktop and the user have been registered and/or to which subscription has been granted for services employing a public secured session. In each secured session, the server's identity is unique, private, registered, and is secured on the user's desktop using a dynamic key that may be provided only by the primary secure server, thus providing for a unique secured session between the desktop and each server registered. The database is secured in such a fashion as to make it not transportable from the desktop on which it is installed. This database would contain all the unique information required to establish an immediate secured session between the host server and the known entity, such as the host's IP address and the desktop's registry information.

II. Secured Session Form 2: Private Internet Network

As an example, the second form of a secured session allows no public component to the Internet host site. Under such circumstances, because the persistent data control application is pre-registered with the server, the session can be instantiated immediately upon the secure exchange of the dynamic session key, or upon user authentication in the form required by the data owner's policy and the secure exchange of the dynamic session key. The first instance that the remote desktop connects with the host server, a secured session begins to be built. Only the unique identifier needs to be passed from the remote browser to the server to establish a secured session because the user is already a registered and known entity.

The persistent data control application can also serve additional functions on the desktop. For example, it might be embedded in or called by an application on the desktop and might be used as a network interface other than a browser to connect with the Internet and the secure server.

The secured session, in either its public or its private form, may be extended beyond the communications session between the server and the desktop. Data, applications, and resources on the desktop owned and/or controlled by the server are or may be secured until the session has been established, at which time the unique key(s) required to gain access to, use, or render the data is passed to the desktop. Rules of accessing, using, and rendering the data are encoded into the data secured on the desktop and may only be overridden upon granting of permission by the server. A description of this feature is further detailed below under the heading “Remote Authorization for Rendering of Secured Data on a Remote Apparatus.”

If the owner's policy allows, the persistent data control application installed on a desktop and licensed to a user may be ported to and installed on another desktop or apparatus. However, the following conditions will then apply: (1) none of the previously-secured data provided via a download and secured on the original desktop will be transportable to the new desktop; (2) all registrations and/or subscriptions with previous servers using a secured session must be renewed. Policy to deal with re-subscribing must be incorporated into each server's services, as defined by the owner's policy, so that at no time may there be a desktop license registered on two different desktops or to two different users. One of the advantages of the present invention is that it prevents fraudulent access to the data and protects the user in case there has been a theft of the system where the persistent data control application is installed.

III. Remote Authorization for Rendering Secured Data on a Remote Apparatus

A process wherein secured data can only be rendered, accessed, or used by a remote apparatus upon establishing a communication session with a control apparatus that provides information and/or the key(s) to unlock the secured data for rendering, accessing or using by the remote apparatus. The secured data may be of any type, comprising documents, control information, software programs, applications, images, video, music, and database information, etc. The process in its entirety, as described below, applies both to the control of secured data that is resident on or is downloaded via a communications medium to the user's remote apparatus, and to the control of data secured only on a distributed storage medium.

The process relies upon a secure communication methodology, e.g., a secured session, which may be standard or proprietary, between the control apparatus and the remote apparatus, such that the control apparatus grants the remote apparatus the rights to render, use, or access the secured data.

The process further incorporates a control apparatus that may be an administrative/authorization computer or similar apparatus that is not limited to any specific type or brand of computer or operating system and that has the functionality to perform all required tasks of the process comprising: (1) authorizing the remote rendering, accessing, or using the secured data which may be resident on, downloaded to the remote apparatus, or stored on distributed media to be rendered on the remote apparatus; (2) interfacing with all required internal applications and databases necessary to provide such administrative components as data keys and such functionalities as subscriber validation and charges; (3) securing all communications with the remote user by the means specified and used by the control apparatus; and (4) communicating with the remote apparatus over a network, be it public, private, or proprietary in nature.

The administrative functions of the control apparatus further include the following: (1) tracking all secured data requested, distributed, authorized, rendered, used, and/or accessed by a remote apparatus; (2) consummating a transaction between a control apparatus and a remote apparatus; and (3) tracking all identifying data pertaining to a remote apparatus that is subscribed or known to the control apparatus and that has rights to the secured data. The process may also incorporate administrative functions that enable a remote apparatus to view, subscribe to and order the secured data, and whenever charges apply, to complete a secure financial transaction.

The process also comprises a remote apparatus, such as a computer or set-top box, that includes functions and capacities for: (1) accepting a distributed storage medium containing the secured data; (2) communicating securely with a control apparatus to which the remote apparatus has rights or subscribes, or with which it is authorized to communicate; (3) using the key(s) provided by a control apparatus to unlock the secured data for rendering, use, or access; (4) rendering, giving access to or using the secured data as prescribed by the control apparatus; and (5) interfacing with any and all input and output apparatus necessary for use or control.

The security for communication between the control apparatus and the remote apparatus may or may not be the same as the security used to secure the data on the storage medium to be rendered, accessed or used by the remote apparatus. The security of the process must include secure means of moving the key(s) to the remote apparatus to enable the rendering, accessing or using of the secured data by the remote apparatus and if required, a secure methodology for consummating any other form of transaction securely over a private or public communications medium, such as the Internet.

The security of the data persists, having used the persistent data control application throughout the process, except as the data is rendered, accessed, or used by the remote apparatus according to the policies and rules established by the owner of the data. The owner of the data dictates the rules and policy for rendering, accessing, and using the secured data and, the remote apparatus has the means to enforce the rules at the time of rendering, accessing, and/or using the secured data. The rules and policy for rendering, accessing or using the secured data remain persistent as defined by the owner of the data regardless its control apparatus be at the secure server or at the remote apparatus. The rules and policy that may be dictated by the process required by the control apparatus, once the secured data has been rendered and accessed, comprise one or more functionalities, such as printing, copying, saving, or specifying an allotted time or a number of times that the secured data may be used or when the data may be rendered.

The process allows an open distribution of the secured data, such that, if a storage medium containing the secured data can be transported to another remote apparatus, that apparatus, being either a known subscriber or a new subscriber, may communicate with the control apparatus in order to be granted the rights to render, access, or use the secured data contained on the distributed storage medium. Thus, the secured data is apparatus- and subscriber-independent, but the control of the secured data remains with the control apparatus throughout the process described herein.

The following figures, FIGS. 9-12, and their descriptions may incorporate or be preceded by standard methodologies to authenticate a user to the control apparatus or a remote apparatus to a control apparatus, and to the secure exchange required dynamic session keys.

Turning now to FIGS. 9A-9B, one embodiment of a flow diagram for establishing a secured session with a registered user in accordance with the principles of the present invention. This method may be preceded by a standard authentication methodology for user or apparatus and transfer of a session dynamic key. In FIG. 9A, a remote apparatus 174 calls the system to request a secured session and transmittal of data in block 176. Then, a unique identifier is encoded with a level 1 encode key and sent to a server 182 in block 178. A level 1 encode may use a custom key of the Virtual Private Network (VPN) or a time stamp if a public secured session to encode is requested. The remote apparatus subsequently awaits return status from the server 182 in block 180.

The server 182 parses the data packet or HTML for an identifier on extension and decodes the identifier in block 184. The server calls the secure server and decodes the data in block 186. Then, a call to a registry component is made and the unique identifier is validated in block 188. If the user is not valid in block 190, i.e. the “no” path, a call to a security audit and a trace component is made in block 192 in order to trace and log an illegal remote session, and the session is terminated in block 194.

If a valid user is established in block 190, i.e. the “yes” path, the server looks up the encode keys for the remote user on the unique identifier in the registry in block 196. The keys are then passed to the secured session for all future session encoding in block 198. The server then initiates building of a secured session for the remote user in block 200. Next, a request for user authentication is generated in block 202, and a call to a secured session and encode is made in block 204. Subsequently, the server sends to the remote user an encoded request for user identification or password in block 206.

Next, the remote apparatus decodes the server request using level 2 user keys in block 208. In one embodiment, the level 2 encode uses three keys out of four for encoding purposes. The password or digital signature is then entered in block 210. Then, the remote apparatus determines whether the password or signature is valid in block 212. The remote apparatus then performs either a desktop validation check and terminates the session in block 214 or proceeds to encode a password or signature using level 3 encode in block 216. The level 3 encode uses the password/signature as a fourth key for the secured session component to complete the secured session on desktop encoding in block. The encoded password or signature is then sent for authentication to the server in block 218. The process continues on in FIG. 9B.

In FIG. 9B, after the remote apparatus sends the encoded password or signature for authentication to the server, the server parses the encoded password or signature and passes the received data to the secure server in block 220. The secure server 220 is called and decoded on Level 3 keys in block 222. A call to a user authentication component is then made in block 224, and the password or signature is validated in block 226. If the password or signature is not valid, i.e. the “no” path, a call is placed to a security audit and trace components to trace and log an illegal remote session in block 228. Then, the session is terminated in block 230.

If a valid password or signature is received from block 226, i.e. the “yes” path, the secure server is authorized in block 232, and in block 234, the final key is passed to the persistent data control application for all future secure server encoding. A complete generation of a secured session for a remote user on the server is then made in block 236. The status is generated and the server is ready for services requested from the remote user in block 238. A call to the secure server and encode is requested in block 240, and the encoded status is sent to the remote user in block 242.

Then, the remote apparatus 174 decodes the data packet or HTML using all remote user keys and authorization in block 244. Next in block 246, the status is validated, and the secure session is set as complete. A request message is then generated in block 248, and encoded on all keys, in block 250, with a level 3 encode by using all keys known to the secure server component for the secure server encoding. The remote apparatus then sends the encoded request to the server for further processing in block 252.

FIGS. 10A-10F are functional block diagrams of various embodiments illustrating a method of registering and establishing a secured session with a new registered user in accordance with the principles of the present invention. This method may be preceded by a standard authentication methodology for user or apparatus and transfer of a session dynamic key. In FIG. 10A, at a client secure application or browser 254 initiates a session and encodes a unique ID, which is sent to a secure server 256 through a communications network 258, e.g., the Internet. The secure server 256 decodes the unique ID and searches for the ID in a subscriber registry database 260 for a license key. The secure server 256 then initiates the generation of a user secured session on the secure server 256.

As shown in FIG. 10B, the secure server 256 encodes and sends a requests for a unique apparatus key to the client secure application where the client secure application or browser 254 is located through the communications network 258. The client secure application or browser 254 decodes, and the request for a unique apparatus key is then processed.

As shown in FIG. 10C, the client secure application or browser 254 encodes a unique apparatus key which is sent to the secure server 256 through the communications network 258. The secure server 256 then decodes and passes the unique apparatus ID to the registry database 260. The secure server 256 continues to build a user secured session on the secure server 256. Subsequently, the subscriber registry database 260 is searched for the ID and is updated with the unique apparatus key.

As shown in FIG. 10D, the secure server 256 encodes a session status and requests authorization and sends it to the client secure application through the communications network 258. The client secure application or browser 254 then decodes and processes the session status and requests authentication.

As shown in FIG. 10E, the user enters a password/authorization code which is then encoded at the client secure application 256 and is sent from the client secure application 256 through the communications network 258 to the secure server 256. At the secure server 256, a decode is performed, and the password or authorization is passed to an authorization server 262.

As shown in FIG. 10F, the authentication status is passed to the secure server 256 and is encoded. The session status is completed and sent through the communications network 258 to the client secure application that then decodes. The process session status is then complete.

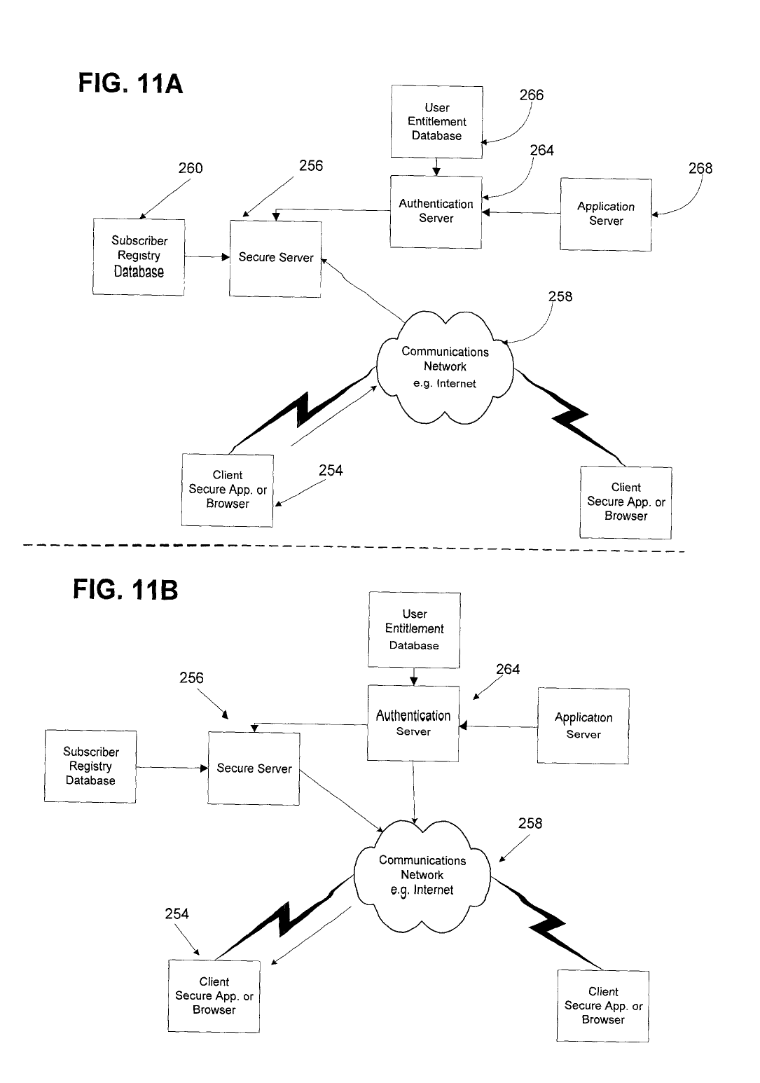

FIGS. 11A-11B are functional block diagrams of various embodiments illustrating a method of requesting for specific content or data key and rendering in accordance with the principles of the present invention. This method may be preceded by a standard authentication methodology for user or apparatus and transfer of a session dynamic key. In FIG. 11A, the client secure application or browser 254 requests an authorization to encode for the unique data ID which is sent to the secure server 256 via the communications network 258. At the secure server 256, a decode is performed, the subscriber is verified from the subscriber registry database 260, and the data and subscriber ID are passed onto a data application server 264. The data application server 264 makes a query to a database 266 for verification of account with a subscriber usage database 268, and for information such as applicable charges. The data application server 264 also obtains authorization keys for the data from the database 266 if the account is verified.

In FIG. 11B, the data application server 264 sends the authorization keys to the secure server 256. The secure server 256 encodes data and the data keys or just the data keys and sends the data and/or the data keys to the client secure application or browser 254 for rendering.

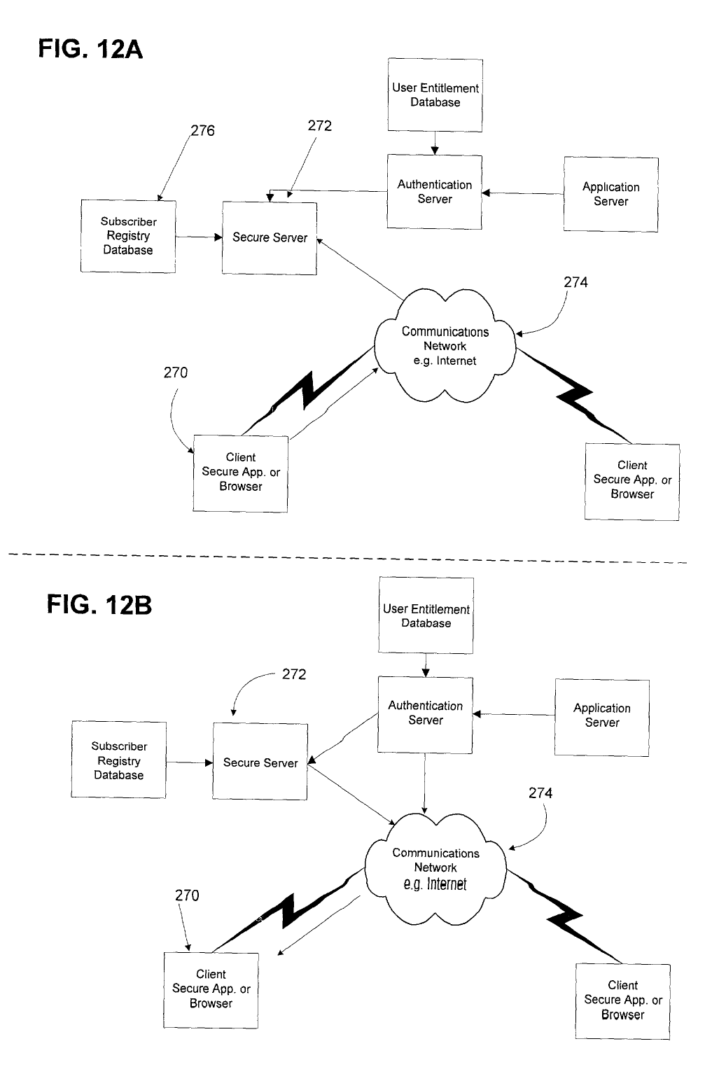

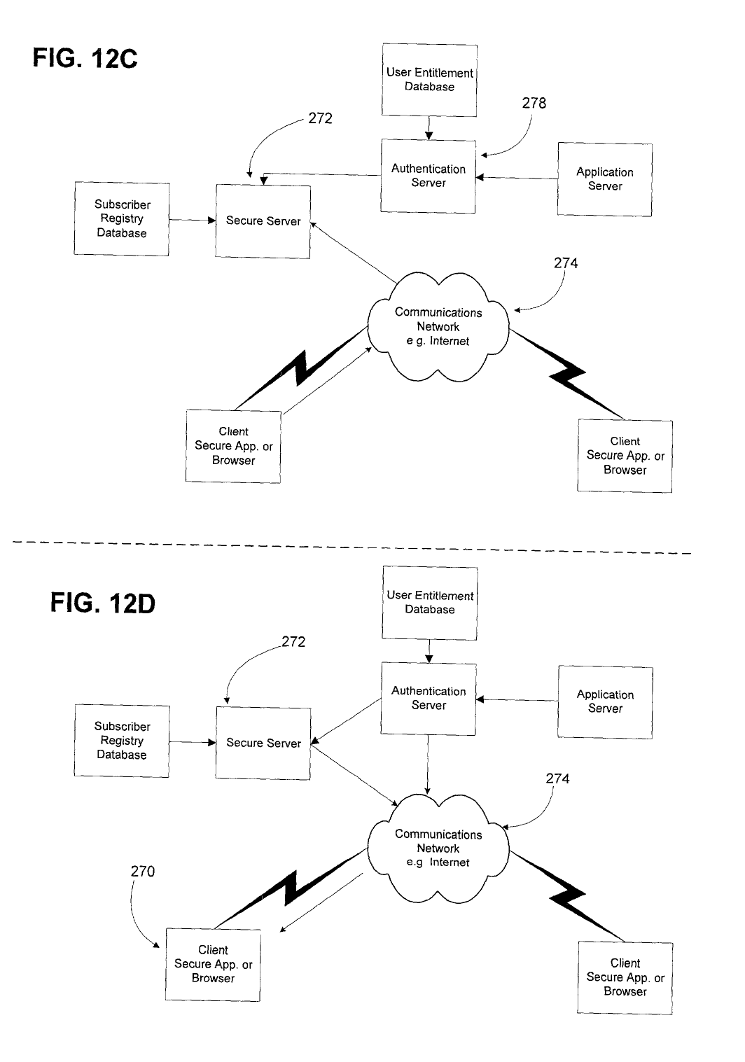

FIGS. 12A-12D are functional block diagrams of various embodiments illustrating a method of establishing a secured session with a registered user in accordance with the principles of the present invention. This method may be preceded by a standard authentication methodology for user or apparatus and transfer of a session dynamic key. In FIG. 12A, a secured session is initiated on a client secure application or browser 270. A unique ID is encoded and sent to a secure server 272 through a communications network 274. The secure server 272 decodes the unique ID, searches on the ID in a subscriber registry database 276 and initiates the generation of a user secured session on the secure server 272.

As shown in FIG. 12B, the secure server 272 encodes the session status on and sends a request authentication through the communications network 274 to the client secure application where the client secure application or browser 270 is located. The secure application or browser then decodes, processes the session status, and requests authorization.

As shown in FIG. 12C, a user password authorization code is entered and encoded at the client secure application. The encoded password/authorization code is then sent through the communications network 274 to the secure server 272. At the secure server 272, the encoded password/authorization code is decoded, and the password or authorization code is then passed to an authorization server 276.

As shown in FIG. 12D, the authentication status is passed to the secure server 272, is encoded session status complete and sent through the communication network 274 to the client secure application or browser 270. At the client secure application or browser 270, the authentication status is decoded, and the session status complete is then processed.

The following are examples of the implementation of a persistent data control system. It is appreciated that other implementations can be used without departing from the present invention.

One example of the implementation is that a persistent data control system in accordance with the present invention is a component of a hosted web service and a client browser. The hosted web site having a secure server has access to all subscriber authentication, profile, access rights and usage databases. Accordingly, the data is encoded according to the use and access rights of a particular subscriber using encoding keys for a specified user to build a secure session and for a particular data type as necessary. User and apparatus authentication to the server may occur in any standard or customized manner deemed necessary by the installation hosting the web content or services. The URL markup language and other referenced content of a web page requested by the subscriber may be encoded as a single file or individually as per implementation of the persistent data control system on a hosted server that forms a secure server in accordance with this invention. The persistent data control system embedded in an end user's browser, i.e. the secure client browser, decodes the encoded access and/or use rules embedded within the encoded file and/or data type. The data is then rendered according to the use rules embedded within the encoded file and/or data type. As an example, the rules may specify that at no time will any of the web page or its referenced content be stored on the device. The browser will therefore be disabled from allowing the user to print, copy or store such content in the Internet Temporary Folder, as is customary or in any other folder as may be desirable by the user. Furthermore, the web page may be transactional in nature and require a simple response, change, or entry of one or more data fields where, upon a response from the user, the secure client browser encodes such data according to the rules embedded within the encoded web page using the appropriate session and data keys and return such encoded data to the server. The server then decodes such information using the appropriate keys and process the decoded data in accordance with its application.

In the foregoing example, one of the encoded data types of the encoded file may be a database having a specific structure and an image or multiple images that are part or referenced in the database. An example of such encoded database and referenced images is a patient DICOM medical record. Being desirable to use the Internet for transmitting a patient DICOM medical record and the browser to render the encoded data types, the persistent data control system in accordance with the present invention can control the access to the data elements within the patient DICOM medical record and the images and their use according to the access and use rights encoded with the file or each data type independently. Thus, a patient DICOM medical record requiring that at no time any part of it be separated from the whole, the complete record may be sent to various users whereupon each user of a different user group may only gain access and use the data according to its user group access and use rights mapped into the encoded file or data type. Such access and use rights are enforced by the secure client browser upon rendering the data by the browser. The above examples may be implemented by a client application having the access by programmatically calling the persistent data control system, or may be implemented by having the persistent data control system be embedded within the client application itself.

Yet another exemplary implementation of the present invention is for the purpose of securing e-mail and its content according to the rules of the owner of the data whether the data originates from a server or a user. The persistent data control system may be embedded in a user's e-mail application. The originator of an e-mail may specify the access and use rights for the body of the e-mail as well as any attachments of the e-mail. The e-mail may be sent to another user having the persistent data control system incorporated into their e-mail service and render the body and attachments of the e-mail in accordance with the rules defined by the originator of the e-mail. Such rules persist for the life of the e-mail and in the manner defined. This example may be implemented in a variety of ways. One such manner of implementation utilizes a secure server to arbitrate e-mail movement wherein the body of an encoded e-mail may be decoded by a secure server using session keys of an originator. The same body of the email is encoded with recipient's session keys. The attachments may be left encoded because the keys to them are embedded within the encoded control information of the encoded file, or because the originator may require the recipient to request the keys from the originator or from the secure server at the time the e-mail and its attachments are to be rendered. Other implementations may be utilized without departing from the spirit of this invention.

IV. Security Software Application

The security software application in accordance with the present invention provides a method of encoding and decoding digital data. The security software application provides an encoding mechanism via a random number generator for all possible character sets and a program or logic means for scrambling the information such that no character are represented by itself or reside in its original position. The security software application employs one or more random number generator keys in a manner that prevents the data from being decoded on any apparatus other than the one targeted. The security software application may be incorporated and/or embedded into other applications or systems.

The owner of the data can extend and enforce the policies and rules that govern and control the data and its life cycle to a targeted recipient of the data. Specific data controls that may be granted and enforced include the ability to read, write, copy and/or print, the term the data are retained, and whether the data are retained on the apparatus in a secure or open form. The security software application secures the data to any apparatus having a unique identifier and allows access to the unique identifier. The application may also lock the data to an individual, wherein means for authenticating the individual's identity is imposed or required. Program or logic means of authentication include passwords, biometrics, certificate authority, and/or digital signatures, etc.

The mechanism for encoding and decoding to and from a buffer or file facilitates control over the rendered data and the applications in a given operating environment. The applications that utilize data streaming, such as music or movies, over a network may utilize a buffer-to-buffer or file-to-buffer feature to ensure the security of the data over the network as well as to prevent its capture and copying.

The security software application relates generally to a method of securing digital data, wherein any file type or data stream type can be secured with or without the use of a standard encryption algorithm. The file type or data type may comprise documents, control information, software programs, applications, images, video, music, database information, and any other digitized analog information of any length. The method in accordance with the present invention does not increase the size of the original information substantially. For example, the method according to the present invention merely adds an encrypted header to the original file. The encrypted header does not increase the original file size by a significant amount, usually no more than 1500 bytes. Furthermore, the method may be applied to digital streams comprising video or voice streaming. Moreover, the encoding process can be re-applied to the same data multiple times to increase the degree of security.

In another embodiment of the present invention, the data is encrypted and formatted in a database file format. The file includes a header that has a plurality of fields. At least one of the fields defines the data's persistent control policy that controls use rights of a recipient. The data persistent control policy is granted by the owner of the data.

In accordance with the principles of the present invention, the method may generate a single file type that is verifiable to prevent attacks and spoofing of the encoded data. For example, the single encoded file type may be checked at a firewall or a proxy to validate the data before allowing them to enter into the system and decoded to prevent unauthorized access or attacks on the system.

The method according to the security software application also allows the owner of the data to define the policies or rules for rendering, accessing, and using the encoded data. Such policies or rules are a part of the encoding scheme and data and, are enforced when the recipient receives and decodes the data. The method in accordance with the invention further provides multiple key schemes, a method to define and control the use of the keys, and the encoding and decoding logic. The method in accordance with the invention also can prevent decoding of the data except on a specific apparatus and by a specific person and software installation.

A process by which digital data secured/encoded and unsecured/decoded by incorporating: (1) means for organizing the digital information; (2) logic or program means for inputting the data to the encoding process from a buffer, a stream, or a file, and logic or program means for outputting the data to a buffer as a stream or a file; (3) the logic or interfaces to incorporate any standard or customized encryption and decryption logic; (4) a key template for encoding the data types or the composite file; (5) logic or program means of building a master seed from unique sub-keys used by the random number generator; (6) logic or program means for encoding the control information for the data types or composite file; (7) logic or program means for encoding the rules of rendering, accessing, and using the data; (8) logic or program means for encoding and decoding the data types; (9) logic or program means for enforcing the rendering rules; (10) logic or program means for establishing the use and source of keys for encoding and decoding and the establishing the process flow of the encoding and decoding process; (11) logic or program means for decoding that is in effect the reverse process of encoding; (12) means for determining and rendering the data useless if the secured information has been altered in any way; (13) means for allowing a definition of how and from where the data is input and output from the encoding and decoding process; and (14) logic or program means for encoding multiple files and their encoded headers and concatenating multiple files into a composite searchable encoded file.

The encode and decode process preferably comprises the following components: headers, file encode, file decode, buffer encode, buffer decode, encode/decode templates, key, rendering rules, rendering, process logic and level flow. Each of these components is described below in detail.

### A. Headers

As described above, the data control elements can be included in a header or other parts of the composite file. For simplicity and illustration, a header is used herewith.

A composite file header is generated for the complete encoded file and for individual data types and is comprised of the pointers to each individual encoded data type and information that allows the process to control its logic and encode level. The logic and level flow information defines what key or key set are used to decode and how the decoding process occurs. The process flow is set by the process itself in a networked environment or programmatically to enable the implementation of one set of source code in potentially many different environments.

Each encoded data type may have its own encoded header of a variable length and comprises process control information. The encoded header includes the length of the encoded digital information, the length of the original file, the original file name, and the type extension. Other information within the header comprises a dynamic key and its change status, a set of rendering rules, a date of creation. This header also contains a set of rendering rules to include but not limited to, an expiration date for the rendering of the data and a counter and decrementor for controlling the number of times the data can be rendered, accessed or otherwise used.

### B. Data Encode

Data are read and encoded in accordance with the standard or customized encryption algorithm being utilized. The secure application implementing the encryption algorithm incorporates a mechanism enabling and for identifying whether the source of the information to be encoded from a buffer or a file is provided. A bit is set in the encrypted header for identifying the data source and defines how the input of the information is to be handled during the file encode process, and the lengths are set in the encrypted header. This is due to the fact that data from a buffer may be streamed and of an indeterminable length until the last byte is read. Alternatively, a file has a fixed length.

### C. Data Decode

Data from the encoded header is decrypted and used to initialize the key and the dictionary and other related processing. Segments are read from the encoded data segment in the same manner as described in File Encode. The mechanism for identifying whether the output of the information to be decoded to a buffer or a file is provided. A bit is set in the encrypted header at the time of the file encode process to define to the file decode process how the output of the information is to be handled. Data may be sent to a buffer or a file and then stored or rendered by an application or viewer. Output to a buffer prevents any intermediary or permanent file from being created and provides greater control of the decoded data. The output of the decode process is written to a file of the same length as the original input data file along with its original file extension.

### D. Keys & Seed

One or more keys may be used to create the encode/decode key(s). This process may incorporate multiple keys that can be used singularly, and in various combinations, dependent upon the logic and encode level flow, and keys may further be encoded into the header. Any combination of the keys and in various combinations, dependent upon the logic and encode level flow fixed or dynamic keys may be used for the encode and decode of all headers and data.

Generally, the term “key” and the term “seed” are interchangeably used. The term “compound key” and the term “key set” are also interchangeably used.

The following describes an exemplary source and use of the keys but is not limited to such. The length of the keys may vary from 4 to 32 characters/bytes in accordance with the encryption method. The values of the keys are acted upon to create a single value from which no less than 32 bits are extracted from some random portion that is defined by the program and is used as the key for the encryption process.

The first key is global and dynamic and is stored in the encoded header of the file. This key dynamically generated by the secure server application for a user session and is always transmitted in a secure fashion using any standard or custom methodology to insure its security. Furthermore the dynamic key is stored only in random memory and never stored on a permanent storage medium.

The second key is the unique license number of the secure software installed on the apparatus. In a network environment, this key is registered on the client apparatus at the time the client secure application software is installed and on the server subscriber database. This key is accessible to the server for encode and decode by requesting and receiving the client ID that is associated with the licensed software distributed to the client. The client ID is used to index the database for the license key.

The third key is a unique number of the apparatus upon which the client secure application is installed. This key is retrieved from the apparatus each time it is to encode or decode data. In a network environment where two or more apparatuses exchange encoded information, the key are stored in the server subscriber database and accessible by using the client ID in the same format as the license key. This key is passed once, upon the initial registration of the user or client, using the dynamic and the license keys to secure the keys so as to protect the keys in transmission, and is then placed into the server subscriber database for later retrieval and use.

The fourth key is a dynamic key that can be used for a password, digital signature, some other user identifying or authenticating mechanism, or any other required system or user definable key.

The keys are processed together to generate a compound seed, e.g. a master key, which is fed to the encryption algorithm for purpose of encoding and decoding of all header and data in accordance with the encode logic and flow.

### E. Rules of Rendering

The means for the owner to establish the rules or policies for rendering, accessing, and/or using the encoded information and the means for these rules to be encoded into the file header. These rules incorporate: (a) control of how the data are saved on the decoding apparatus; (b) if the data is to be retained as an encoded file and whether the data may be printed, displayed or saved as an open file; (c) the number of times the encoded data may be viewed before the rendering process erases the encoded file; (d) a length of time or days the encoded file is retained for viewing before the rendering process erases or destroys the information; and/or (e) how the data is to be viewed or rendered.

### F. Rendering

A programmatic means to pass the rules to and control a rendering component by which they are enforced. The secure component of the present invention incorporates a default rendering engine that monitors, updates, enforces the rules for use of the data such as text, image, audio, image, and video data when control of an external rendering application is not available to enforce the rules. Furthermore, the rendering component also provides the interfaces necessary to be implemented within an application and enforce the rendering rules. The encoded data is decoded to a memory buffer from which it is rendered to the printer, display device, or any other output device where the controls are available to prevent the ability of the recipient to save the data to any other file format outside the secured format. Once the rendering component has determined the rules governing the number of uses or expiration date have expired, and if and how the secured data may be saved on the rendering apparatus, the secured file is erased from the apparatus or the storage medium upon which the secured file resides, or allowed to be stored in an open decrypted format or in it encrypted format in accordance with the rules and policies incorporated in the encrypted header or the encrypted data.

The interfaces and the adaptability exist such that upon knowing the interfaces that control a rendering application, the required control to enforce the rules can be applied in any application. This is extremely applicable to players for video or music currently being moved over the Internet.

### G. Logic and Encode Level Flow

The encode and decode process is made up of components that can be controlled programmatically or be set based upon how it is to be used by a system or the application that may call it or in which it may be embedded. The following encode level setting determines the flow through the process, use of the keys, and conditions for encode and decode.

Level 1 uses the dynamic key for encode and decode.

Level 2 uses the dynamic, license, and apparatus keys.

Level 3 incorporates and provides the interface for the dynamic key to be input and used.

Level 4 uses the dynamic key and is connected to a server that provides a unique dynamic key for encode. At the time of decode, the recipient is connected to the server, which provides the dynamic key to enable decode.

It is appreciated that additional levels may be used and can be reserved for expansion and customization as necessary.

Having described the present invention in the exemplary embodiments, modifications and equivalents may occur to one skilled in the art. It is intended that such modifications and equivalents shall be included within the scope of the claims which are appended hereto.

What is claimed is:

1. A method of securely distributing data on a network, comprising the steps of:
a) providing an encoded file of a single file type having a plurality of file control fields, the file having at least one data type; and
b) incorporating at least one encoded use right into one of the control fields of the at least one data type.

2. The method of claim 1, wherein the step a) is performed at an application level.

3. The method of claim 1, wherein the method is capable of being embedded in an application which originates the at least one data type.

4. The method of claim 1, wherein the method is called by an application.

5. The method of claim 1, further comprising the step of:
c) incorporating multiple encoded use rights into the control fields of the at least one data type.

6. The method of claim 1, further comprising the step of:
c) incorporating at least one encoded access right into one of the control fields of the at least one data type.

7. The method of claim 5, further comprising the step of:
d) incorporating at least one encoded access right into one of the control fields of the at least one data type.

8. The method of claim 1, wherein the method is performed in a distributed network environment.

9. The method of claim 1, wherein the method is performed in the Internet environment.

10. The method of claim 1, wherein the method is performed in an Intranet environment.

11. The method of claim 1, wherein the encoded use right is encoded with the at least one data type.

12. The method of claim 1, wherein the encoded use right is encoded independently from the at least one data type.

13. The method of claim 1, further comprising the step of:
c) decoding the plurality of file control fields including a file control field for the at least one encoded use right.

14. The method of claim 13, further comprising the step of:
d) decoding the at least one data type.

15. The method of claim 14, further comprising the step of:
e) rendering the decoded data type in accordance with the decoded use right.

16. The method of claim 6, further comprising the step of:
d) decoding the plurality of file control fields including a file control field for the at least one encoded use right.

17. The method of claim 16, further comprising the step of:
e) decoding the plurality of the file control fields including a file control field for the at least one encoded access right.

18. The method of claim 17, further comprising the step of:
f) decoding the at least one data type in accordance with the decoded access right.

19. The method of claim 18, further comprising the step of:
g) rendering the decoded data type in accordance with the decoded use right.

20. A system for securely distributing data on a network, comprising:
an encoded file of a single file type having a plurality of file control fields, the file having at least one data type; and
means for incorporating at least one encoded use right into one of the control fields of the at least one data type.
